(19) United States
(12) Patent Application Publication
(10) Pub. No.: US 2012/0130800 A1
(43) Pub. Date: May 24, 2012

(54) SYSTEMS AND METHODS FOR ASSESSING ADVERTISING EFFECTIVENESS USING NEUROLOGICAL DATA

(76) Inventors: Anantha Pradeep, Berkeley, CA (US); Ramachandran Gurumoorthy, Berkeley, CA (US); Robert T. Knight, Berkeley, CA (US)

(21) Appl. No.: 13/304,234

(22) Filed: Nov. 23, 2011

Related U.S. Application Data
(60) Provisional application No. 61/417,137, filed on Nov. 24, 2010.

(51) Int. Cl. G06Q 30/02

(52) U.S. Cl. 705/14.41

(57) ABSTRACT

Example methods, systems and machine readable instructions are disclosed for assessing advertising effectiveness based on neurological data. An example method includes analyzing neuro-response data from a panelist exposed to media to determine a first score representative of an attention level of the panelist, a second score representative of an emotional engagement of the panelist, and a third score representative of memory activity of the panelist. In addition, the example method includes calculating a persuasion metric, a novelty metric and an awareness metric based on the first, second and third scores.

### RELATED APPLICATION

This patent claims the benefit of U.S. Provisional Patent Application Ser. No. 61/417,137, entitled “Media Effectiveness Assessment Using Neuro-Response Measures,” which was filed on Nov. 24, 2010, and which is incorporated herein by reference in its entirety.

### FIELD OF THE DISCLOSURE

This disclosure relates generally to advertising, and, more particularly, to systems and methods for assessing the effectiveness of advertising based on neurological data.

### BACKGROUND

Traditional systems and methods for assessing the effectiveness of advertising are often limited and rely on extensive reviews of sales data.

### BRIEF DESCRIPTION OF THE DRAWINGS

FIG. 1 is a schematic illustration of an example system constructed in accordance with the teachings of this disclosure to assess advertising effectiveness based on neurological data.

FIG. 2 is a Venn diagram showing example relationships of the example scores and metrics determined with the example system of FIG. 1.

FIG. 3 is a flow chart representative of example machine readable instructions that may be executed to implement the example system of FIG. 1.

FIG. 4 illustrates an example processor platform that may execute the instructions of FIG. 3 to implement any or all of the example methods, systems and/or apparatus disclosed herein.

### DETAILED DESCRIPTION

Disclosed herein are example apparatus, systems, methods and machine readable media to assess media such as advertising and advertising campaigns using neurological or neuro-response data collected from one or more panelist(s) while or after the panelist(s) are exposed to the media. In some examples, the neuro-response data is analyzed to generate component scores such as an attention level score, an emotional engagement score and/or a memory activity or retention score. In some examples, the scores are used to calculate one or more metric(s) such as, for example, a persuasion metric, a novelty metric and/or an awareness metric. The effectiveness of the advertising is based on one or more of the attention level score, the emotional engagement score, the memory activity score, the persuasion metric, the novelty metric and/or the awareness metric.

Conventional assessments of the effectiveness of media such as advertising rely on behavior-based data and/or survey data collected from subjects exposed to the advertising. For example, behavior-based data may include data collected by measuring changes in sales of products or services following a media campaign such as an advertising campaign. In other examples, the subjects exposed to advertising may be asked to complete surveys after exposure to determine the effect of the exposure or after a purchase to evaluate the contribution exposure to the advertising campaign made to the purchase. However, sales analysis requires many resources, a willingness and cooperation from companies to provide sensitive and confidential information and/or the probability that factors other than an advertising campaign (e.g., consumer needs, seasonal effects, etc.) contributed to the sales figures or a change therein. Also, survey results provide only limited and sometimes inaccurate information about a panelist's experience.

Examples disclosed herein provide techniques for accurate assessments of the effectiveness of advertising. As disclosed herein, neuro-response data is analyzed to derive the component scores for a panelist's attention level, emotional engagement, and/or memory activity or retention. Attention level measures sustained focus and/or shifts in focus over time. Although attention can be shifted voluntarily (i.e., controlled or top-down attention, which is attention given by a panelist to information and/or stimulus on which the panelist chooses to focus), sustaining focus is difficult. Many types of stimuli (e.g., advertisements or portions or elements of an advertisement) can automatically affect attention (i.e., automatic or bottom-up attention, which is attention that is involuntarily given by a panelist to information and/or stimulus). Emotional engagement measures intensity of emotional response and automatic emotional classification of stimuli. Emotional engagement is an affective response, both to the stimulus and its processing. Non-conscious emotional responses often drive attention, choices, and behavior. Memory activity or retention measures formation of connections and activation of personal relevance. Memory can be explicit (e.g., articulate in explicit recall) or implicit in encoding of significantly relevant stimuli. Memory stimulates learning by creating and reinforcing connections that allow later retrieval of related information.

In some examples disclosed herein, the component scores (e.g., the attention level score, the emotional engagement score and/or the memory activity score) are weighted. For example, the emotional engagement of an advertisement may be of particular importance for a specific client. In another example, attention level may be weighted as more important for young adults in determining an effectiveness score. In such examples, the emotional engagement score or attention level score is weighted to have a greater influence on the analysis of effectiveness. The scores (weighted or unweighted) are combined to generate an advertising effectiveness score that corresponds to the effectiveness of the advertising in providing a particular emotional response, grabbing attention, increasing the fame or notoriety of the corresponding products and services, eliciting additional sales of corresponding products and/or services and/or other measures of success and/or effectiveness of the advertising. Weights applied to the various component scores may vary depending on many attributes of the advertising such as, for example, the industry of the products and/or services, the product, the service, the company or advertiser, the demographics of the targeted audience, the geographic distribution of the advertising, the type and/or duration of the advertising campaign involved, the marketing medium and/or other suitable attributes or factors. The marketing medium may include, for example, online (e.g., Internet) media, mobile (e.g., cellular phone, smart phone, iPad® tablet, etc.) media, television media, radio media, and/or print media.

In some examples, attention level, emotional engagement and/or memory activity are used to generate or calculate marketplace performance metrics and the general effectiveness score. Some example performance metrics include persuasion, novelty and awareness. Persuasion indicates a likelihood of attitude or behavior change such as, for example, a propensity to purchase a product or service or to view a program. Persuasion is derived from a combination of emotional engagement and memory activation. For example, a person displays neural markers of persuasion when experiencing positive “approach” emotion and also updating memory in anticipation of a future action. Even if the person has a low attention level, the memory activity indicates that the stimulus (e.g., the advertisement) is more likely to be recognized in a later decision-making context or action context.

Novelty indicates something is new and worth remembering such as, for example, that something stands out in the marketplace. Novelty is derived from a combination of attention level and memory activity. An object or situation is seen as novel to the extent it appears to provide new knowledge. Novel stimuli are new and different and provide an opportunity for learning. Memory is activated to incorporate this new information and to connect it to existing knowledge.

Awareness indicates something is understandable and comprehensible. Understanding occurs when a subject focuses on something (e.g., there is an increase in attention level) and a connection with the subject's emotional frameworks of comprehension occurs. Thus, awareness is derived from a combination of emotional engagement and attention level.

In some disclosed examples, the persuasion, novelty and awareness metrics are aggregated to assess the effectiveness of advertising (e.g., predict an increase in sales based on the advertising). The metrics, like the component scores described above, may be weighted based on, for example, industry, product and/or service, brand, demographic group, geographic distribution etc., depending on what aspect(s) of an advertisement or advertising campaign are important to a particular study. The metrics also may be aggregated. In some examples, the aggregated metrics are used to assess advertising effectiveness. Component scores, metrics and/or effectiveness scores allow companies, advertisers, publicity firms and/or other interested parties to modify advertisements and/or advertising campaigns to increase effectiveness as well as to intelligently allocate resources to particularly effective advertisements and/or campaigns.

Example methods disclosed herein include obtaining neuro-response data from a panelist exposed to media such as, for example, an advertisement. Example methods also include analyzing, using a processor, the neuro-response data to determine a first score representative of an attention level of the panelist, a second score representative of an emotional engagement of the panelist, and a third score representative of memory activity of the panelist. In addition, example methods include calculating, with the processor, a persuasion metric, a novelty metric and/or an awareness metric for the media based on the first, second and/or third scores.

Some example methods include weighting at least one of the first, second and/or third score to emphasize at least a corresponding one of the attention level, the emotional engagement and/or the memory activity. In some examples, the media comprises an advertisement associated with at least one of a brand, a target demographic, a geographic distribution and/or a marketing medium and the weighting is customized based on at least one of the brand, the target demographic, the geographic distribution and/or the marketing medium.

Some examples disclosed herein also include determining an effectiveness of the media (e.g., an advertisement) based on the first, second and third scores. Also, some examples include determining an effectiveness of the media (e.g., an advertisement) based on the persuasion metric, the novelty metric and/or the awareness metric.

In some examples, the persuasion metric is based on the second and third scores. In some examples, the novelty metric is based on the first and third scores. Also, in some examples, the awareness metric is based on the first and second scores.

In some disclosed examples, the neuro-response data includes first encephalographic data from a first frequency band of brain activity of the panelist and second encephalographic data from a second frequency band of the brain activity, the second frequency band being different from the first frequency band. In some examples, the neuro-response data is analyzed to identify an interaction between the first frequency band and the second frequency band, and the interaction is indicative of attention level, emotional engagement and memory activity.

In addition, in some examples disclosed herein, the neuro-response data includes first data collected using a first data collection modality and second data collected using a second data collection modality, the second data collection modality being different than the first data collection modality.

Example systems disclosed herein include a data collector to obtain neuro-response data from a panelist exposed to media (e.g., an advertisement). Some example systems also include a data analyzer to analyze the neuro-response data to determine a first score representative of an attention level of the panelist, a second score representative of an emotional engagement of the panelist, and a third score representative of memory activity of the panelist. In some example systems, the data analyzer is to calculate a persuasion metric, a novelty metric and/or an awareness metric for the media based on the first, second and third scores.

Example tangible machine readable medium storing instructions are disclosed herein. The example instructions, when executed, cause a machine to at least obtain neuro-response data from a panelist exposed to media (e.g., an advertisement). The example instructions, when executed also cause a machine to analyze the neuro-response data to determine a first score representative of an attention level of the panelist, a second score representative of an emotional engagement of the panelist, and a third score representative of memory activity of the panelist. In some examples, the instructions, when executed, cause a machine to calculate a persuasion metric, a novelty metric and/or an awareness metric for the media based on the first, second and/or third scores.

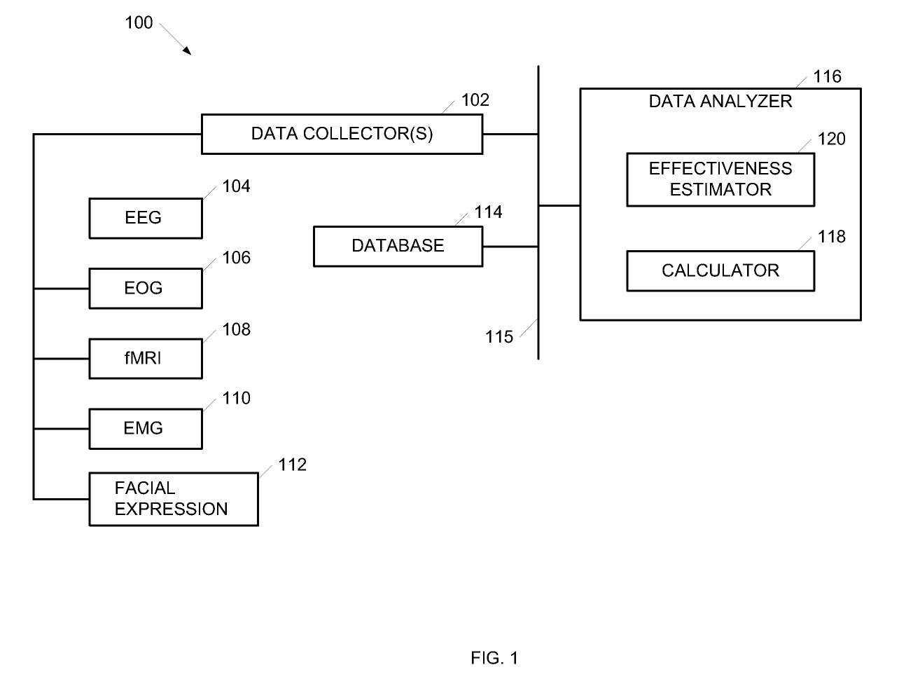

FIG. 1 illustrates an example system 100 to assess advertising effectiveness using neurological data. The example system 100 of FIG. 1 includes one or more data collector(s) 102 to obtain neuro-response data from a panelist while or after the panelist is exposed to an advertisement. The example data collector(s) 102 of FIG. 1 may include, for example, one or more electrode(s), camera(s) and/or other sensor(s) to gather any type(s) of neurological and/or physiological data, including, for example, functional magnetic resonance (fMRI) data, electroencephalography (EEG) data, magnetoencephalography (MEG) data and/or optical imaging data. The data collector(s) 102 of the illustrated example may gather data continuously, periodically and/or aperiodically.

The data collector(s) 102 of the illustrated example gather neurological and/or physiological measurements such as, for example, central nervous system measurements, autonomic nervous system measurement(s) and/or effector measurement(s), which may be used to evaluate a panelist's reaction(s) and/or impression(s) of one or more advertisement(s) and/or content. Some examples of central nervous system measurement mechanisms that are employed in some examples detailed herein include fMRI, EEG, MEG and optical imaging. Optical imaging may be used to measure the absorption or scattering of light related to concentration of chemicals in the brain or neurons associated with neuronal firing. MEG measures magnetic fields produced by electrical activity in the brain. fMRI measures blood oxygenation in the brain that correlates with increased neural activity.

EEG measures electrical activity resulting from a large number of simultaneous neural processes associated with different portions of the brain. EEG also measures electrical activity associated with post synaptic currents occurring in the milliseconds range. Subcranial EEG can measure electrical activity with high accuracy. Although bone and dermal layers of a human head tend to weaken transmission of a wide range of frequencies, surface EEG provides a wealth of useful electrophysiological information. In addition, portable EEG with dry electrodes also provides a large amount of useful neuro-response information.

EEG data is collected from multiple different frequency bands. Brainwave frequency bands include delta, theta, alpha, beta, and gamma frequency ranges. Delta waves are classified as those less than 4 Hz and are prominent during deep sleep. Theta waves have frequencies between 3.5 to 7.5 Hz and are associated with memories, attention, emotions, and sensations. Theta waves are typically prominent during states of internal focus. Alpha frequencies reside between 7.5 and 13 Hz and typically peak around 10 Hz. Alpha waves are prominent during states of relaxation. Beta waves have a frequency range between 14 and 30 Hz. Beta waves are prominent during states of motor control, long range synchronization between brain areas, analytical problem solving, judgment, and decision making Gamma waves occur between 30 and 60 Hz and are involved in binding different populations of neurons together into a network for the purpose of carrying out a certain cognitive or motor function, as well as in attention and memory. Because the skull and dermal layers attenuate waves above 75-80 Hz, brain waves above this range may be difficult to detect. Nonetheless, in some of the disclosed examples, high gamma band (kappa-band: above 60 Hz) measurements are analyzed, in addition to theta, alpha, beta, and/or low gamma band measurements to determine a panelist's reaction(s) and/or impression(s) (such as, for example, attention, emotional engagement and/or memory). In some examples, high gamma waves (kappa-band) above 80 Hz (detectable with sub-cranial EEG and/or MEG) are used in inverse model-based enhancement of the frequency responses indicative of a panelist's reaction(s) and/or impression(s). Also, in some examples, panelist and task specific signature sub-bands (i.e., a subset of the frequencies in a particular band) in the theta, alpha, beta, gamma and/or kappa bands are identified to estimate a panelist's reaction(s) and/or impression(s). Particular sub-bands within each frequency range have particular prominence during certain activities. In some examples, multiple sub-bands within the different bands are selected for analysis while other frequencies are blocked via band pass filtering. In some examples, multiple sub-band responses are enhanced, while the other frequency responses may be attenuated.

Interactions between frequency bands are demonstrative of specific brain functions. For example, a brain processes the communication signals that it can detect. Data in a higher frequency band may drown out or obscure data in a lower frequency band. Likewise, data with a high amplitude may drown out data with low amplitude in the same or different bands. Constructive and/or destructive interference may also obscure data based on their phase relationship. In some examples, the neuro-response data captures activity in different frequency bands and analysis thereof may determine that a first band may be out of a phase with a second band. Such out of phase waves in two different frequency bands are indicative of a particular communication, action, emotion, thought, etc. In some examples, brain activity in one frequency band is active while brain activity in another, different, frequency band is inactive, which enables the brain to detect the active band. A circumstance in which one band is active and a second, different band is inactive is indicative of a particular communication, action, emotion, thought, etc. For example, neuro-response data showing increasing theta band activity occurring simultaneously with decreasing alpha band activity provides a measure that internal focus is increasing (theta) while relaxation is decreasing (alpha), which together suggest that the panelist is actively processing the stimulus (e.g., the advertisement).

Autonomic nervous system measurement mechanisms that are employed in some examples disclosed herein include electrocardiograms (EKG) and pupillary dilation, etc. Effector measurement mechanisms that are employed in some examples disclosed herein include electrooculography (EOG), eye tracking, facial emotion encoding, reaction time, etc. Also, in some examples, the data collector(s) 102 collect other type(s) of central nervous system data, autonomic nervous system data, effector data and/or other neuro-response data. The example collected neuro-response data may be indicative of one or more of alertness, engagement, attention, memory, and/or resonance.

In the illustrated example, the data collector(s) 102 collect neurological and/or physiological data from multiple sources and/or modalities. In the illustrated, the data collector(s) 102 include components to gather EEG data 104 (e.g., scalp level electrodes), components to gather EOG data 106 (e.g., shielded electrodes), components to gather fMRI data 108 (e.g., a differential measurement system), components to gather EMG data 110 to measure facial muscular movement (e.g., shielded electrodes placed at specific locations on the face) and/or components to gather facial expression data 112 (e.g., a video analyzer). The data collector(s) 102 may also include one or more additional sensor(s) to gather data related to any other modality including, for example, GSR data, MEG data, EKG data, pupillary dilation data, eye tracking data, facial emotion encoding data and/or reaction time data. Other example sensors include cameras, microphones, motion detectors, gyroscopes, temperature sensors, etc., which may be integrated with or coupled to the data collector(s) 102.

In some examples, only a single data collector 102 is used. In other examples a plurality of data collectors 102 are used. Data collection is performed automatically in the example of FIG. 1. In addition, in some examples, the data collected is digitally sampled and stored for later analysis such as, for example, in a database 114. In some examples, the data collected is analyzed in real-time. According to some examples, the digital sampling rates are adaptively chosen based on the type(s) of physiological, neurophysiological and/or neurological data being measured.

In the example system 100 of FIG. 1, the data collector(s) 102 are communicatively coupled to other components of the example system 100 via communication links 116. The communication links 116 may be any type of wired (e.g., a databus, a USB connection, etc.) or wireless communication mechanism (e.g., radio frequency, infrared, etc.) using any past, present or future communication protocol (e.g., Bluetooth, USB 2.0, etc.). Also, the components of the example system 100 may be integrated in one device or distributed over two or more devices.

The illustrated example system 100 of FIG. 1 includes a data analyzer 116. The example analyzer 116 receives the data gathered from the data collector(s) 102 and analyzes the data for trends, patterns and/or relationships. The analyzer 116 of the illustrated example reviews data within a particular modality (e.g., EEG data) and between two or more modalities (e.g., EEG data and eye tracking data). Thus, the analyzer 116 of the illustrated example provides an assessment of intra-modality (e.g., data collected within a single data collection type) measurements and cross-modality (e.g., data collected using two or more data collection types) measurements.

With respect to intra-modality measurement enhancements, in some examples, brain activity is measured to determine regions of activity and to determine interactions and/or types of interactions between various brain regions and/or various frequencies of brain activity. Interactions between brain regions support orchestrated and organized behavior. Attention, emotion, memory, and/or other abilities are not based on one part of the brain but instead rely on network interactions between brain regions. Thus, measuring signals in different regions of the brain and timing patterns between such regions provides data from which attention, emotion, memory and/or other neurological states can be recognized. In addition, different frequency bands used for multi-regional communication may be indicative of a panelist's reaction(s) and/or impression(s) (e.g., a level of alertness, attentiveness and/or engagement). Thus, data collection using an individual collection modality such as, for example, EEG is enhanced by collecting data representing neural region communication pathways (e.g., between different brain regions) in different frequency bands. Such data may be used to draw reliable conclusions of a panelist's reaction(s) and/or impression(s) (e.g., engagement level, alertness level, etc.) and, thus, to provide the bases for determining if advertising was effective. For example, if a panelist's EEG data shows high theta band activity occurring simultaneously with high gamma band activity, both of which are indicative of memory activity, an estimation may be made that the panelist's reaction(s) and/or impression(s) to contemporaneously presented advertisement or content is one of alertness, attentiveness and engagement.

With respect to cross-modality measurement enhancements, in some examples, multiple modalities to measure biometric, neurological and/or physiological data is used including, for example, EEG, GSR, EKG, pupillary dilation, EOG, eye tracking, facial emotion encoding, reaction time and/or other suitable biometric, neurological and/or physiological data. Thus, data collected using two or more data collection modalities may be combined and/or analyzed together to draw reliable conclusions on panelist states (e.g., engagement level, attention level, etc.). For example, activity in some modalities occurs in sequence, simultaneously and/or in some relation with activity in other modalities. Thus, information from one modality may be used to enhance or corroborate data from another modality. For example, an EEG response will often occur hundreds of milliseconds before a facial emotion measurement changes. Thus, a facial emotion encoding measurement may be used to enhance an EEG emotional engagement measure. Also, in some examples EOG and eye tracking are enhanced by measuring the presence of lambda waves (a neurophysiological index of saccade effectiveness) in the EEG data in the occipital and extra striate regions of the brain, triggered by the slope of saccade-onset to estimate the significance of the EOG and eye tracking measures. In some examples, specific EEG signatures of activity such as slow potential shifts and/or measures of coherence in time-frequency responses at the Frontal Eye Field (FEF) regions of the brain that preceded saccade-onset are measured to enhance the effectiveness of the saccadic activity data. Some such cross modality analyses employ a synthesis and/or analytical blending of central nervous system, autonomic nervous system and/or effector signatures. Data synthesis and/or analysis by mechanisms such as, for example, time and/or phase shifting, correlating and/or validating intra-modal determinations with data collection from other data collection modalities allow for the generation of a composite output characterizing the significance of various data responses and, thus, the classification of attributes of a property and/or representative based on a panelist's reaction(s) and/or impression(s).

In some examples, actual expressed responses (e.g., survey data) and/or actions for one or more panelist(s) or group(s) of panelists may be integrated with biometric, neurological and/or physiological data and stored in the database or repository 114 in connection with one or more advertisement(s). In some examples, the actual expressed responses may include, for example, a panelist's stated reaction and/or impression and/or demographic and/or preference information such as an age, a gender, an income level, a location, interests, buying preferences, hobbies and/or any other relevant information. The actual expressed responses may be combined with the neurological and/or physiological data to verify the accuracy of the neurological and/or physiological data, to adjust the neurological and/or physiological data and/or to determine the effectiveness of the advertising. For example, a panelist may provide a survey response that details why a purchase was made. The survey response can be used to validate neurological and/or physiological response data that indicated that the panelist was engaged and memory retention activity was high.

In the illustrated example, the data analyzer 116 analyzes the neuro-response data in accordance with the example techniques described above, and determines, using for example a calculator 118, a first component score for an attention level of the panelist exposed to the advertisement, a second component score for an emotional engagement of the panelist exposed to the advertisement and a memory activity of the panelist exposed to the advertisement. The score may be, for example, a numerical value. The numerical value may correlate with an absolute or relative measurement of the neuro-response data indicative of the component (e.g., indicative of the attention, emotion and/or memory). The score may be weighted if, for example, a particular component is of greater importance to a particular analysis than the other components. Weighting is discussed further below. The numerical values may correspond to the intensity of neuro-response measurements, the significance of peaks of neuro-response activity, a change between peaks, etc. Higher numerical values may correspond to higher significance in neuro-response intensity. Lower numerical values may correspond to lower significance or even insignificant neuro-response activity. The numerical values may also reflect changes and/or consistency in the neuro-response data after repeated exposure.

In some examples, the calculator 118 determines one or more metric(s) based on one or more of the component score(s). For example, the calculator may determine a persuasion metric, a novelty metric and/or an awareness metric. In some examples, the calculator 118 determines the persuasion metric based on the emotional engagement score and the memory activity score. In some examples, the calculator 118 determines the novelty metric based on the attention level score and the emotional engagement score. Also, in some examples, the calculator 118 determines the awareness metric based on the attention level score and the memory activity score.

In some examples, the calculator 118 determines the persuasion metric, the novelty metric and/or the awareness metric using a summing equation including, for example, a linear or nonlinear combination of the factors that drive the metric. That is, the calculator 118 performs a summing operation using the component scores relevant to a particular metric. The summing operation may involve polynomials, log-log data and/or other mathematical functions and/or data values. An example combination to determine a measure of a metric is shown below in Equation (1).

$$measure = {\sum }_{r = 0 to n} A \times {factor}_{1}^{α r} \times {factor}_{2}^{β r} \qquad Eqn . ( 1 )$$

The variable r represents a summing index, A, α and β represents constants that are customized based on the particular analysis. For example, different products, brands, and/or industries may use different constants in this equation, and/or the constants may be adjusted based on particular weighting requirements, as described below. Thus, using Equation (1), the measure of the metric for persuasion is equal to the sum of the emotional engagement score (e.g., factor₁) multiplied by the memory activity score (e.g., factor₂) as adjusted by the constants. The measure of the metric for novelty is equal to the sum of the attention level score (e.g., factor₁) multiplied by the emotional engagement score (e.g., factor₂) as adjusted by the constants. Also, the measure of the metric for awareness is equal to the sum of the attention level score (e.g., factor₁) multiplied by the memory activity score (e.g., factor₂) as adjusted by the constants.

In other examples, the combinations used by the calculator 118 to determine the metrics include a time or frequency evolution of the synchrony among the driving factors (e.g., the component scores) including, for example, the correlation, covariance, coherence, or coupling (amplitude coupling or phase coupling) measurements of the components scores. An example of such calculation is shown below in Equation (2).

$$measure = \frac{Cov ( {factor}_{1} , {factor}_{2} )}{\sqrt{VAR ( {factor}_{1} ) * VAR ( {factor}_{2} )}} \qquad Eqn . ( 2 )$$

Covariance is a measure of how much two variables change together. Variance is a special case of the covariance when the two variables are identical.

Thus, using Equation (2), the measure of the metric for persuasion is equal to the covariance of the emotional engagement score (e.g., factor₁) and the memory activity score (e.g., factor₂) divided by the square root of the product of the variance of the emotional engagement score (e.g., factor₁) and the memory activity score (e.g., factor₂). The measure of the metric for novelty is equal to the covariance of the attention level score (e.g., factor₁) and the emotional engagement score (e.g., factor₂) divided by the square root of the product of the variance of the attention level score (e.g., factor₁) and the emotional engagement score (e.g., factor₂). Also, the measure of the metric for awareness is equal to the covariance of the attention level score (e.g., factor₁) and the memory activity score (e.g., factor₂) divided by the square root of the product of the variance of the attention level score (e.g., factor₁) and the memory activity score (e.g., factor₂).

In other examples, other mathematical operations may be applied by the calculator 118 to determine the persuasion, novelty and/or awareness metrics such as, for example, coherence, correlation, coupling and/or any other suitable process.

In some examples, one or more of the component scores and/or one or more of the marketplace performance metrics are weighted so that a particular component and/or particular metric is emphasized in the effectiveness assessment (e.g., an advertising effectiveness measurement). For example, an assessment may intend to determine how heavily attention can impact effectiveness relative to emotion or memory. In such example, the attention level score may be given more weight in the effectiveness analysis. An example of weighting a component or metric includes increasing the variables associated with the component or metric in the equations used in the effectiveness analysis. For example, if the attention level score were to be given an increased weight, an example novelty metric measurement using Equation (1) may increase “A” for the attention level score and/or increase α in relation to β.

The example system 100 of FIG. 1 also includes an effectiveness estimator 120. The effectiveness estimator 120 of the illustrated example analyzes one or more of the component score(s) and/or the marketplace performance metric(s) and determines the success or level of effectiveness of the component, the metric and/or the overall advertisement or advertising campaign. The effectiveness estimator 120 of the illustrated example reviews one or more attributes of a particular study or analysis to determine the effectiveness. The attributes may include, for example, product or service attributes, target audience demographics, geographic attributes, advertising campaign goals, and/or other suitable attributes. The attributes are associated with each particular study and may be stored in the database 114 to which the effectiveness estimator 120 is communicatively coupled. In some examples, if a study attribute indicates that the persuasion metric is of critical importance, the effectiveness estimator 120 determines an advertising campaign to be highly effective based on a high persuasion metric even if the attention level component score (which does not influence persuasion) was low.

In some examples, the effectiveness estimator 120 may determine a correspondence between the weighted or unweighted component scores or metrics for one or more product(s), service(s), product type(s), brand(s), category(ies), demographic group(s), target audience(s), geographic region(s), etc. and/or actual effectiveness. Actual effectiveness may be, for example, changes in total sales, volume, price, market share, etc. The effectiveness score may be used to modify an advertising campaign. For example, particular advertisement(s) that are found to be ineffective may be removed from a particular advertising campaign.

While example manners of implementing the example system 100 to assess advertising effectiveness has been illustrated in FIG. 1, one or more of the elements, processes and/or devices illustrated in FIG. 1 may be combined, divided, re-arranged, omitted, eliminated and/or implemented in any other way. Further, the example data collector(s) 102, the example database 114, the example data analyzer 116, the example calculator 118, and/or the example effectiveness estimator 120 and/or, more generally, the example system 100 of FIG. 1 may be implemented by hardware, software, firmware and/or any combination of hardware, software and/or firmware. Thus, for example, the example data collector(s) 102, the example database 114, the example data analyzer 116, the example calculator 118, and/or the example effectiveness estimator 120 and/or, more generally, the example system 100 of FIG. 1 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example data collector(s) 102, the example database 114, the example data analyzer 116, the example calculator 118, and/or the example effectiveness estimator 120 are hereby expressly defined to include hardware and/or a tangible computer readable medium such as a memory, DVD, CD, etc. storing the software and/or firmware. Further still, the example system 100 of FIG. 1 may include one or more elements, processes and/or devices in addition to, or instead of, those illustrated in FIG. 1, and/or may include more than one of any or all of the illustrated elements, processes and devices.

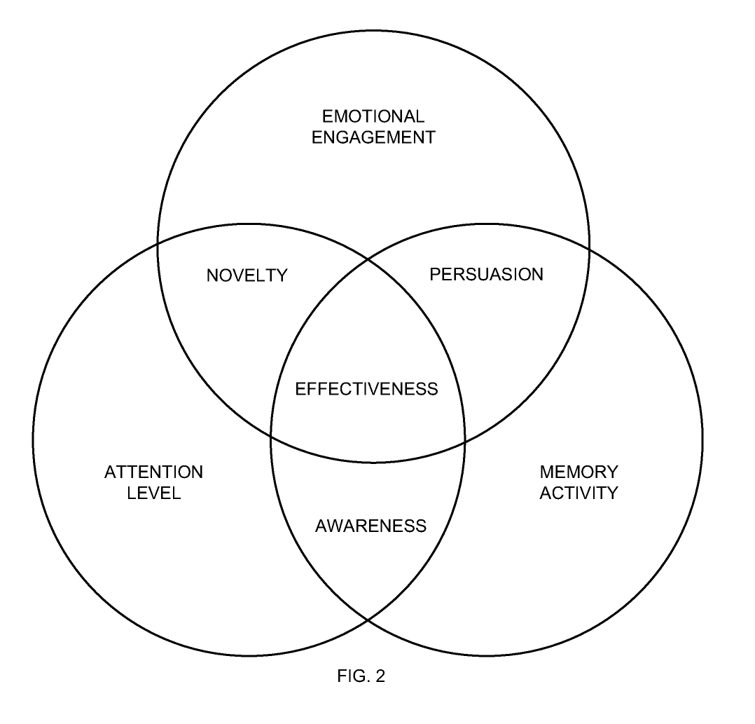

FIG. 2 is a Venn diagram that illustrates the relationship among the components, the metrics and the effectiveness. As shown in FIG. 2, the emotional engagement component and the memory activity component are factors for the persuasion metric. The attention level component and the emotional engagement component are factors of the novelty metric. The attention level component and the memory activity component are factors for the awareness metric. One or more of the attention level component, the emotional engagement component, the memory activity component, the persuasion metric, the novelty metric and/or the awareness metric are factors for the effectiveness score.

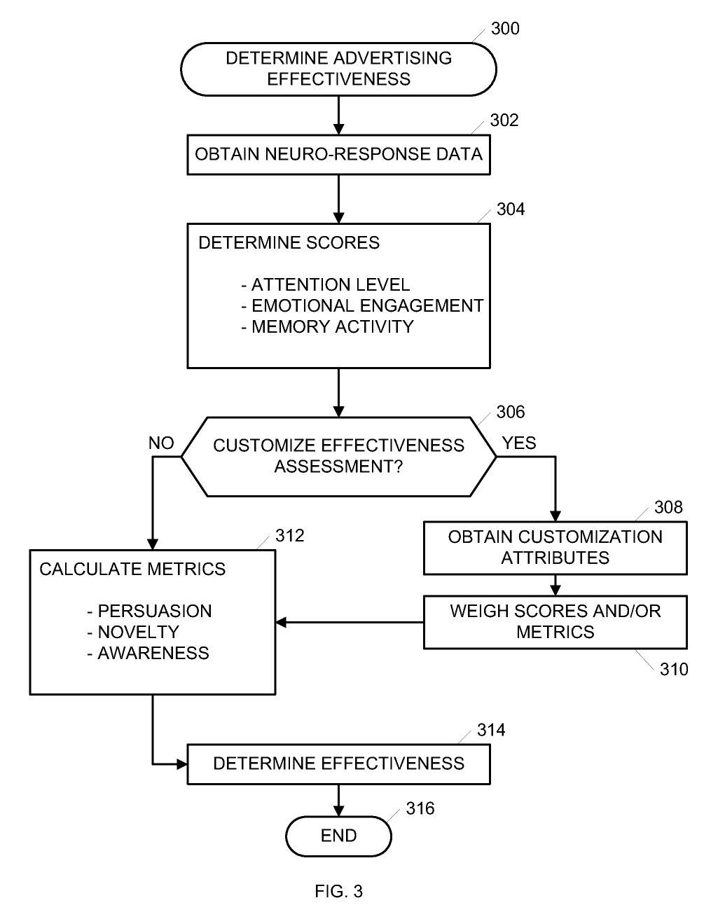

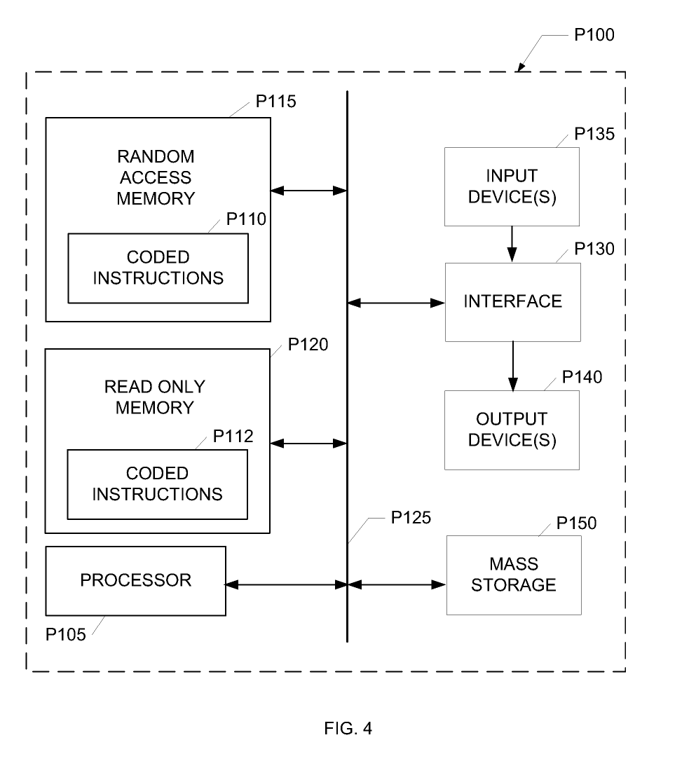

FIG. 3 is a flowchart representative of example machine readable instructions that may be executed to implement the example system 100, the example data collector(s) 102, the database 114, the example data analyzer 116, the example calculator 118, the example effectiveness estimator 120 and/or other components of FIG. 1. In the example of FIG. 3, the machine readable instructions include a program for execution by a processor such as the processor P105 shown in the example computer P100 discussed below in connection with FIG. 4. The program may be embodied in software stored on a tangible computer readable medium such as a CD-ROM, a floppy disk, a hard drive, a digital versatile disk (DVD), or a memory associated with the processor P105, but the entire program and/or parts thereof could alternatively be executed by a device other than the processor P105 and/or embodied in firmware or dedicated hardware. Further, although the example program is described with reference to the flowchart illustrated in FIG. 3, many other methods of implementing the example system 100, the example data collector(s) 102, the database 114, the example data analyzer 116, the example calculator 118, the example effectiveness estimator 120 and/or the other components of FIG. 1 may alternatively be used. For example, the order of execution of the blocks may be changed, and/or some of the blocks described may be changed, eliminated, or combined.

As mentioned above, the example processes of FIG. 3 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIG. 3 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

FIG. 3 illustrates an example process 300 to determine advertising effectiveness. The example process 300 of FIG. 3 includes obtaining neuro-response data (block 302). For example, neuro-response data may be collected via a plurality of sensors such as, for example, the data collector(s) 102 of FIG. 1. The example process 300 include an analysis of the neuro-response data to determine component score (block 304). Example component scores include numerical values or other types of scores related to, for example, an attention level, an emotional engagement and/or memory activity.

The example process 300 determines if the effectiveness assessment is to be customized (block 306). For example, if the assessment is to be customized, the example process 300 reviews one or more attributes (block 308) related to the assessment including, for example, attributes related to a product, a service, an entertainment production, a demographic characteristic, a geographic scope, a component and/or metric of importance, etc. The attribute(s) provide an indication of what component(s) (attention level, emotional engagement and/or memory activity) and/or metrics (persuasion, novelty and/or awareness) should be given greater or lesser weight in the effectiveness assessment. The example process 300 then weighs the score(s) and/or metric(s) accordingly (block 310).

If example process 300 determines that there is no customization needed for the assessment (block 306), the process 300 continues to calculate the metric measures (block 312) with unweighted data. If any score and/or metric was weighed (block 310), the example process 300 continues to calculate the metric measure (block 312) with the weighted or mixed weighted and unweighted data. The process 300 also determines an effectiveness of the advertising (block 314) based on one or more of the score(s) and/or metric(s). After the advertising effectiveness has been assessed, the example process ends (block 316).

Although FIG. 3 is described in terms of measuring the effectiveness of an advertisement. Other type(s) of content may be analyzed by this process.

FIG. 4 is a block diagram of an example processing platform P100 capable of executing the instructions of FIG. 3 to implement the example system 100, the example sensor 102, the example selector 104, the example display device interface 108, the example data collector 110, the example data collector 201, the example database 122, the example data analyzer 126 and the example accounting module 128. The processor platform P100 can be, for example, a server, a personal computer, or any other type of computing device.

The processor platform P100 of the instant example includes a processor P105. For example, the processor P105 can be implemented by one or more Intel® microprocessors. Of course, other processors from other families are also appropriate.

The processor P105 is in communication with a main memory including a volatile memory P115 and a non-volatile memory P120 via a bus P125. The volatile memory P115 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory P120 may be implemented by flash memory and/or any other desired type of memory device. Access to the main memory P115, P120 is typically controlled by a memory controller.

The processor platform P100 also includes an interface circuit P130. The interface circuit P130 may be implemented by any type of past, present or future interface standard, such as an Ethernet interface, a universal serial bus (USB), and/or a PCI express interface.

One or more input devices P135 are connected to the interface circuit P130. The input device(s) P135 permit a panelist to enter data and commands into the processor P105. The input device(s) can be implemented by, for example, a keyboard, a mouse, a touchscreen, a track-pad, a trackball, isopoint and/or a voice recognition system.

One or more output devices P140 are also connected to the interface circuit P130. The output devices P140 can be implemented, for example, by display devices (e.g., a liquid crystal display, and/or a cathode ray tube display (CRT)). The interface circuit P130, thus, typically includes a graphics driver card.

The interface circuit P130 also includes a communication device, such as a modem or network interface card to facilitate exchange of data with external computers via a network (e.g., an Ethernet connection, a digital subscriber line (DSL), a telephone line, coaxial cable, a cellular telephone system, etc.).

The processor platform P100 also includes one or more mass storage devices P150 for storing software and data. Examples of such mass storage devices P150 include floppy disk drives, hard drive disks, compact disk drives and digital versatile disk (DVD) drives.

The coded instructions of FIG. 3 may be stored in the mass storage device P150, in the volatile memory P110, in the non-volatile memory P112, and/or on a removable storage medium such as a CD or DVD.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method, comprising:
analyzing, using a processor, neuro-response data from a panelist exposed to media to determine a first score representative of an attention level of the panelist, a second score representative of an emotional engagement of the panelist, and a third score representative of memory activity of the panelist; and
calculating, with the processor, a persuasion metric, a novelty metric and an awareness metric for the media based on the first, second and third scores.

2. The method of claim 1 further comprising weighting at least one of the first, second or third score to emphasize at least a corresponding one of the attention level, the emotional engagement or the memory activity.

3. The method of claim 2, wherein the media comprises an advertisement associated with at least one of a brand, a target demographic, a geographic distribution or a marketing medium and the weighting is customized based on at least one of the brand, the target demographic, the geographic distribution or the marketing medium.

4. The method of claim 1 further comprising determining an effectiveness of the media based on the first, second and third scores.

5. The method of claim 1 further comprising determining an effectiveness of the media based on the persuasion metric, the novelty metric and the awareness metric.

6. The method of claim 1 wherein the persuasion metric is based on the second and third scores.

7. The method of claim 1 wherein the novelty metric is based on the first and third scores.

8. The method of claim 1 wherein the awareness metric is based on the first and second scores.

9. The method of claim 1, wherein the neuro-response data includes first encephalographic data from a first frequency band of brain activity of the panelist and second encephalographic data from a second frequency band of the brain activity, the second frequency band being different from the first frequency band.

10. The method of claim 9, wherein the neuro-response data is representative of an interaction between the first frequency band and the second frequency band.

11. The method of claim 1, wherein the neuro-response data includes first data collected using a first data collection modality and second data collected using a second data collection modality, the second data collection modality being different than the first data collection modality.

12. A system comprising:
a data collector to obtain neuro-response data from a panelist exposed to media; and
a data analyzer to analyze the neuro-response data to determine a first score representative of an attention level of the panelist, a second score representative of an emotional engagement of the panelist, and a third score representative of a memory activity of the panelist, and to calculate a persuasion metric, a novelty metric and an awareness metric for the media based on the first, second and third scores.

13. The system of claim 12, wherein the media comprises an advertisement associated with at least one of a brand, a target demographic or a geographic distribution, and the data analyzer is to weigh at least one of the first, second or third score to emphasize at least one of the attention level, the emotional engagement or the memory activity based on at least one of the brand, the target demographic or the geographic distribution.

14. The system of claim 12, wherein the data analyzer is to determine an effectiveness of the media based on at least one of the first, second and third scores or the persuasion, novelty and awareness metrics.

15. The system of claim 12 wherein the persuasion metric is based on the second and third scores, the novelty metric is based on the first and third scores, and the awareness metric is based on the first and second scores.

16. The system of claim 12, wherein the neuro-response data includes first encephalographic data from a first frequency band of brain activity of the panelist and second encephalographic data from a second frequency band of the brain activity, the second frequency band being different from the first frequency band, and the neuro-response data is representative of an interaction between the first frequency band and the second frequency band.

17. The system of claim 12, wherein the data collector includes a first sensor to collect first neuro-response data using a first data collection modality and a second sensor to collect second neuro-response data using a second data collection modality, the second data collection modality being different than the first data collection modality.

18. A tangible machine readable medium storing instructions thereon which, when executed, cause a machine to at least:
analyze neuro-response data from a panelist exposed to media to determine a first score representative of an attention level of the panelist, a second score representative of an emotional engagement of the panelist, and a third score representative of memory activity of the panelist; and
calculate a persuasion metric, a novelty metric and an awareness metric for the media based on the first, second and third scores.

19. The machine readable medium of claim 18 wherein the instructions further cause the machine to determine an effectiveness of the media based on at least one of the first, second and third scores or the persuasion, novelty and awareness metrics.

20. The machine readable medium of claim 18, wherein the persuasion metric is based on the second and third scores, the novelty metric is based on the first and third scores and the awareness metric is based on the first and second scores.
